(19) United States
(12) Patent Application Publication
(10) Pub. No.: US 2024/0077738 A1
(43) Pub. Date: Mar. 7, 2024

(54) Systems With Removable Lenses

(71) Applicant: Apple Inc., Cupertino, CA (US)

(72) Inventors: Matin Seadat Beheshti, Sunnyvale, CA (US); Forrest C Wang, Petaluma, CA (US); Shirley S Lu, Sunnyvale, CA (US)

(21) Appl. No.: 18/322,455

(22) Filed: May 23, 2023

Related U.S. Application Data
(60) Provisional application No. 63/404,225, filed on Sep. 7, 2022.

(51) Int. Cl. G02B 27/01; G02B 7/16

(52) U.S. Cl. CPC G02B 27/0176; G02B 7/16; G02B 2027/0132; G02B 2027/0156; G02B 27/0172; G02B 2027/0178

(57) ABSTRACT

A system such as a head-mounted device may have left and right displays for displaying images. The images may be presented to left and right eye boxes through left and right fixed (non-removable) lenses and corresponding left and right removable vision correction lenses. The left and right fixed lenses may be supported by left and right fixed lens supports to which the left and right displays are mounted, respectively. To removably attach the vision correction lenses to the fixed lenses, the fixed lens supports and vision correction lenses may be provided with bayonet mounts. The bayonet mounts may have push-and-turn structures such as pins that mate with corresponding slots.

This application claims the benefit of provisional patent application No. 63/404,225, filed Sep. 7, 2022, which is hereby incorporated by reference herein in its entirety.

### FIELD

This relates generally to electronic devices, and, more particularly, electronic devices with removable lenses.

### BACKGROUND

Electronic devices such as head-mounted devices may include lenses. Images may be displayed to eye boxes through the lenses.

### SUMMARY

A system such as a head-mounted device may have displays for displaying images. The images may be presented to eye boxes through fixed lenses to which removable vision correction lenses are attached. The removable vision correction lenses may be used to correct for a user's vision errors such as nearsightedness or farsightedness.

The fixed lenses may be mounted in fixed lens supports coupled to a head-mounted housing. The displays and fixed lenses may be mounted to the fixed lens supports. To removably attach the vision correction lenses in alignment with the fixed lenses, the fixed lens supports and vision correction lenses may be configured to form bayonet mounts. The bayonet mounts may have push-and-turn mounting structures such as pins that mate with corresponding slots.

### BRIEF DESCRIPTION OF THE DRAWINGS

FIG. 1 is a top view of a portion of an illustrative electronic device in accordance with an embodiment.

FIG. 2 is diagram of an illustrative bayonet mount for removably attaching a removable vision correction lens to a fixed lens assembly in an electronic device such as the device of FIG. 1 in accordance with an embodiment.

FIG. 3 is a diagram of an illustrative removable lens in accordance with an embodiment.

FIG. 4 is a diagram of an illustrative fixed lens in accordance with an embodiment.

FIG. 5 is a diagram of an illustrative removable lens being removably attached to an illustrative fixed lens with a bayonet mount in accordance with an embodiment.

FIG. 6 is a cross-sectional side view of a portion of a removable lens being attached to a fixed lens support in an optical assembly in accordance with an embodiment.

FIGS. 7, 8, and 9 are cross-sectional side views of portions of illustrative electronic devices with bayonet mounts in accordance with embodiments.

FIG. 10 is a cross-sectional side view of an illustrative spring for a bayonet mount in accordance with an embodiment.

FIG. 11 is a side view of an illustrative lens retention ring with a bayonet mount in accordance with an embodiment.

### DETAILED DESCRIPTION

An electronic device may be provided with bayonet mounts. The bayonet mounts may be used in lens retention rings, removable vision correction lenses, and/or other portions of the electronic device.

The electronic device may be a portable electronic device such as a head-mounted device. The head-mounted device may have fixed lenses (sometimes referred to as non-removable lenses) and displays for presenting images to eye boxes. When the head-mounted device is being worn on the head of a user so that the user's eyes are located in the eye boxes, the user may view the images on the displays through the fixed lenses. To accommodate users with refractive errors and other vision defects, a head-mounted device may have removable prescription lenses (sometimes referred to as removable vision correction lenses). The vision correction lenses may correct for a user's vision errors. For example, if a user is nearsighted, farsighted, and/or has astigmatism, the vision correction lenses may contain the user's prescription for correcting for these refractive errors.

When the vision correction lenses are mounted to the head-mounted device in alignment with the fixed lenses of the head-mounted device, the vision correction lenses may correct for the user's vision defects. As an example, if a user has astigmatism, the vision correction lenses may be used to correct for the astigmatism. Similarly, if the user is nearsighted, the vision correction lenses may have a lens power that corrects for the user's nearsightedness and thereby allows the user to clearly view the images from the displays. When the user desires to clean the removable vision correction lenses or to swap one pair of vision correction lenses for another to accommodate device use by a different user, the vision correction lenses may be removed from the head-mounted device.

To facilitate attachment and removal of the vision correction lenses, each of the vision correction lenses may be provided with a bayonet mount. Bayonet mounts, which may sometimes be referred to as pin-and-slot mounts, key-and-lock mounts, push-and-twist mounts, push-and-rotate mounts, etc., may have interlocking positive and negative structures that facilitate rapid and accurate attachment and detachment of each removable vision correction lens.

Bayonet mounts can be used to lock the vision correction lenses in place, so that the vision correction lenses are securely attached to the head-mounted device and will not come loose during normal device operations. The mounts may provide a desired amount of axial preloading, so that the vision correction lenses are maintained at a known distance from the fixed lenses in the head-mounted device. This helps avoid optical misalignment errors due to uncertainty in the axial location (fixed-lens-to-removable-lens separation) of the vision correction lenses. Accurate rotational alignment of the removable lenses with respect to the fixed lenses is also achieved using the bayonet mounts. Because the vision correction lenses are generally not rotationally symmetric and have peripheral edge shapes that are not circular, the use of bayonet mounting to ensure proper rotational alignment helps ensure that the vision correction lenses will be oriented satisfactorily to correct the user's vision and will satisfy cosmetic requirements.

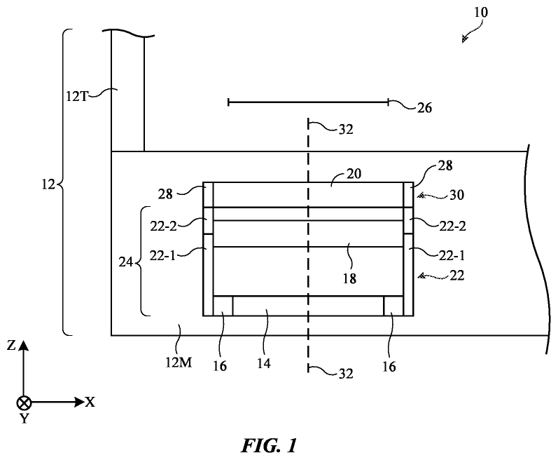

FIG. 1 is a top view of a portion of an illustrative electronic device of the type that may receive one or more components mounted using bayonet mounts. Device 10 may be a cellular telephone, a laptop computer, a wristwatch device, a tablet computer, a head-mounted device (e.g., goggles, glasses, a helmet, etc.), another portable electronic device, and/or any other suitable electronic equipment. In an illustrative configuration, which may sometimes be described herein as an example, device 10 may be a head-mounted device.

As shown in FIG. 1, device 10 may have a head-mounted housing such as housing 12. Housing 12 may have a main portion such as portion 12M (sometimes referred to as a main housing unit) and side portions such as portions 12T (sometimes referred to as eyeglass side supports or temples, straps, etc.). Housing 12 is configured to be worn on the head of a user. When housing 12 is being worn, images are presented to the user's left and right eyes, which are located in left and right eye boxes (see, e.g., illustrative eye box 26 of FIG. 1).

Device 10 may have left and right displays such as display 14 of FIG. 1, which may be aligned respectively with left and right eye boxes 26. A half portion of device 10 is shown in FIG. 1, so only a single display 14 and single corresponding eye box 26 are present in the drawing of FIG. 1. Device 10 may include an identical additional half portion so that left and right eye boxes are provided with left and right images, respectively.

In each half of device 10, a display such as display 14 and a fixed lens such as fixed lens 18 (e.g., a lens that is not removable by an end user, sometimes referred to as a non-removable lens) are mounted in a support structure such as lens support 22. Support 22, which may sometimes be referred to as a lens barrel, lens support, lens assembly support, lens and display support, lens support structure, etc., may be formed from one or more separate structures (see, e.g., hollow cylindrical lens barrel 22-1 and ring-shaped lens barrel trim 22-2 in the example of FIG. 1). Together, lens support 22, display 14, and fixed lens 18 form optical assembly 24. Device 10 contains left and right optical assemblies 24 (sometimes referred to as optical modules or lens barrels) for providing left and right images to the user's left and right eyes in left and right eye boxes. Each optical assembly 24 may contain gaze trackers 16 and/or other optical and/or electrical components.

Left and right removable vision correction lenses (prescription lenses) such as illustrative removable lens 30 may be removably attached to the left and right optical assemblies. The removable lenses that are used on a given device may be selected to provide vision correction specific for a particular user (e.g., a user with a particular eyeglass prescription may attach left and right removable lenses such as lens 30 to respective left and right optical assemblies 24 to correct for vision defects such as refractive errors in the user's left and right eyes. Each lens 30 may include a lens support 28 (sometimes referred to as a lens holder, lens mount, ring-shaped removable lens support, etc.) and a lens (sometimes referred to as a lens element) such as lens 20 that is mounted in lens support 28. Lenses 20, which may sometimes be referred to as prescription lenses or prescription lens elements, are optically configured to correct for the user's vision defects and thereby allow a user to view images from displays 14 clearly when lenses 30 are mounted in alignment with fixed lenses 18.

To allow a user to remove and attach lenses 30 to assemblies 24, the lens support 28 for each removable lens 30 and the lens support 22 for each fixed lens 18 may be provided with mating engagement structures that form a bayonet mount. The bayonet mount allows removable lenses 30 to be accurately and rapidly attached to assemblies 24 and removed from assemblies 24 by a user. Bayonet mounts may be formed by providing supports 28 and 30 with structures that allow lenses 30 to be mounted to assemblies 24 by pushing lenses 30 toward assemblies 24 and rotating lenses 30 and that allow lenses to be removed from assemblies 24 by rotating lenses 30 and then pulling lenses 30 away from assemblies 24. As an example, supports 28 and 30 may be provided with protrusions such as pins that radially protrude inward or outward and mating slots or other recesses that serve to receive the protruding pins. The pins and slots may be comparable in size so that friction between the pins and slots helps to hold the pins in place within the slots after lenses 30 have been mounted to assemblies 24. When a user wishes to attach lens 30 to assembly 24, the user may push lens 30 towards assembly 24 (in the −Z direction in the example of FIG. 1) so that the pin on lens 30 slides axially into its slot on assembly 24, after which the user may rotate lens 30 about rotational axis 32 so that the pin moves within a slot segment that runs at least partly around the peripheral edge of support 22 and thereby secures lens 30 to assembly 24.

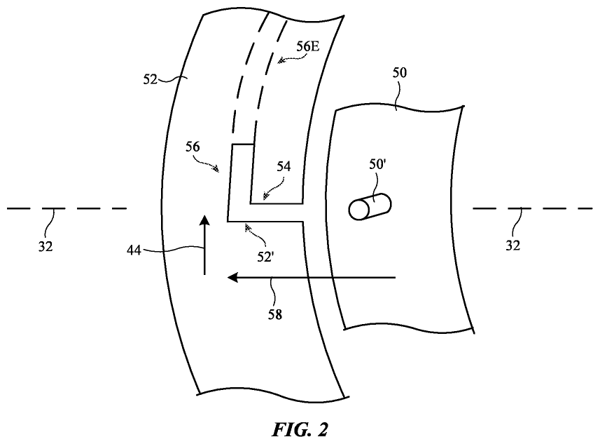

FIG. 2 shows illustrative pin-and-slot structures of the type that may be used to form a bayonet mount for lenses 30. In the example of FIG. 2, two structures are being joined using a bayonet mount: structure 50 and structure 52. In one illustrative scenario, structure 50 is lens support 28 of lens 30 and structure 52 is lens support 22 of optical assembly 24. In another illustrative scenario, structure 52 is lens support 28 of lens 30 and structure 50 is lens support 22 of optical assembly 24. Structure 50 and 52 may be formed from metal, polymer, glass, ceramic, other materials, and/or combinations of these materials. Structures 50 and 52 may be shaped using molding techniques, machining techniques, and/or other fabrication techniques. Optional coatings and/or surface treatments may be used to adjust the friction between mating parts and/or to otherwise configure structures 50 and 52 to form a locking mount such as a bayonet mount.

As shown in FIG. 2, structure 50 may have a protrusion such as pin 50′. Structure 52 may have a slot such as slot 52′ that is configured to receive pin 50′. Slot 52′ may have a first segment such as segment 54 that runs (axially) parallel to rotational axis 32 and a second segment such as segment 56 that wraps at least partly about axis 32. When a user desires to mount structure 50 to structure 52, structure 50 is moved towards structure 52 in direction 58, so that pin 50′ is inserted into slot segment 54. Structure 50 is then rotated relative to structure 52 about axis 32 in direction 44, so that pin 50′ slides within slot segment 56. When the end of segment 56 is reached, pin 50′ will contact the end of segment 56 and any additional movement of segment 56 will be prevented. At this location, friction from the interaction between pin 50′ and slot 52′ (and, if desired, an optional biasing spring) may help maintain structure 50 in a desired axial and rotational position relative to structure 52.

The bayonet mount of FIG. 2 may be configured to provide lens 30 with a desired amount of axial loading (loading along the direction of axis 32 of FIG. 2) relative to assembly 28, a desired axial position with respect to assembly 28 (e.g., placement of lens 30 at a known axial location along axis 32 to ensure satisfactory optical performance), and a desired rotational alignment with respect to assembly 28 (e.g., a known rotational alignment between lens 30 and assembly 28 to ensure satisfactory optical performance and a desired cosmetic appearance). Lens 30 (e.g., ring-shaped support 28 and the peripheral edge of lens 20) may have a non-circular shape so that the overall shape lens 30 is not rotationally symmetric. Lens 20 may also have optical surfaces that are not rotationally symmetric and/or other lens features that are not rotationally symmetric about axis 32, so placement of lens 30 at a known rotational orientation helps ensure that lens 30 performs satisfactorily (e.g., so that lens 30 corrects for the user's vision errors).

Slot segment 56 may extend about some or all of the periphery of structure 52. When slot segment 56 of slot 52′ is relatively short, structures 50 and 52 may only be permitted to rotate by a relatively small amount (e.g., 2°, 1-45°, 5-30°, at least 1°, at least 5°, or at least 20°). If desired, slot segment 56 may be extended farther as shown by optional slot extension 56E (e.g., so that slot segment 56 extends partly or completely around the circumference of structure 52). When extension 56E is sufficiently long to extend more than once around the periphery of structure 52, extension 56E may have a spiral shape that spirals away from structure 50.

During lens mounting operations, the presence of (vertical) slot segment 54 allows pin 50′ to be pushed along slot segment 54 and the presence of (horizontal) slot segment 56 allows pin 50′ to be rotated. Bayonet mounts of the type shown in FIG. 2 may therefore sometimes be referred to as push- and turn-mounts, push-and-twist mounts, push-and-twist connections, push-and-rotate mounting structures, etc. In an illustrative arrangement, clockwise rotation of structure 50 about axis 32 may be used in attaching structure 50 to structure 52 and counterclockwise rotation of structure 50 about axis 32 may be used in detaching structure 50 from structure 52. If desired, slot 56 may extend in the opposite direction from that shown in FIG. 2, so that clockwise rotation is used to detach structure 50 and counterclockwise rotation is used to attach structure 50.

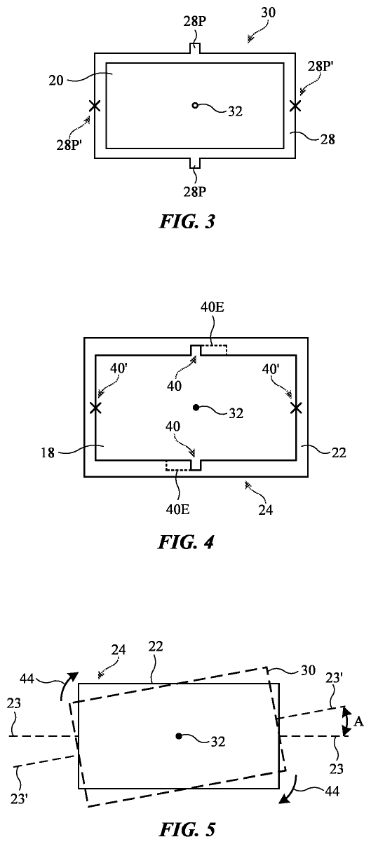

Illustrative bayonet mounting arrangements that allow lenses 30 to be removably mounted to assemblies 28 in device 10 are shown in the top views of lens 30 and assembly 24 of FIGS. 3, 4, and 5.

As shown in the example of FIG. 3, lens 30 may have a shape that is wider horizontally than vertically. Lens 30 (e.g., support 28) may have a rectangular shape, a teardrop shape, or other suitable shape. In some configurations, lens 30 may have a circular outline, but, more generally, the outline of lens 30 will be non-circular. Lens 30 may have protrusion such a pins 28P on lens support 28. Pins 28P may extend in the vertical directions (up and down in the orientation of FIG. 3). If desired, pins may be formed in other locations (see, e.g., optional horizontally extending pins 28P′). As shown in FIG. 4, support 22 of assembly 28 may have mating slots for receiving pins 28P such as slots 40. Slot extensions 40E (e.g., a slot extension such as segment 56E of FIG. 2) may be sized to define an amount of permitted twisting (rotation) of lens 30 and support 28 relative to fixed lens 18 and support 22 during push and twist operations. In arrangements in which optional horizontally extending pins 28P′ are formed on support 28, slots may be formed in support 20 at corresponding side locations of support 22 of assembly 24 such as locations 40′ of FIG. 4.

As shown in FIG. 5, the pins and slots may be formed at locations that allow lens 30 to be attached to support 22 by pushing lens 30 inwardly (into the page of FIG. 5) so that pins 28P travel into slots 40 (e.g., into the page of FIG. 5) followed by rotating lens 30 in direction 44 about axis 32 (e.g., clockwise in the orientation of FIG. 5) so that pins 28P travel along slot extensions 40E (see FIG. 4) to the end of slot extensions 40E. Initially, for example, lens 30 may be oriented so that horizontal lens axis 23′ is angled at a non-zero angle A with respect to horizontal axis 23 of support 22 of assembly 24. After pushing and twisting, lens 30 may rotate into rotational alignment with support 20 so that angle A is 0°.

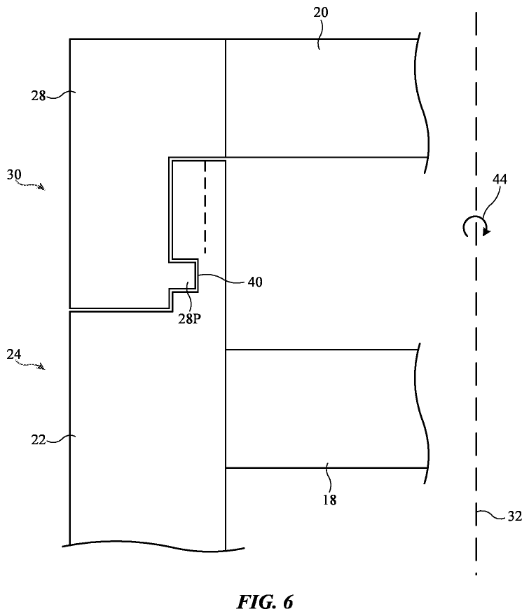

FIG. 6 is a cross-sectional view of a portion of assembly 24 and lens 30 in an illustrative configuration in which support 28 of lens 30 has a pin 28P that protrudes radially inward (towards rotational axis 32) into slot 40 in support 22 of assembly 24, which faces radially outward. As shown in FIG. 6, lens 30 has a ring-shaped support 28 that supports a prescription lens element such as lens 20. Support 22 of assembly 24 may be used to support fixed lens 18. Slot 40 in support 22 initially receives pin 28P vertically (in the orientation of FIG. 6) and allows lens 30 to be pushed onto assembly 24 parallel to axis 32. An extended portion of slot 40 that runs along the periphery of support 22 then receives pin 28P as lens 30 is rotated in direction 44 about axis 32 to attach lens 30 to assembly 24. Reverse rotational movement and pulling of lens element 30 vertically upwards can be used to detach lens 30 when it is desired to switch lenses to accommodate a different user prescription (e.g., for a different user).

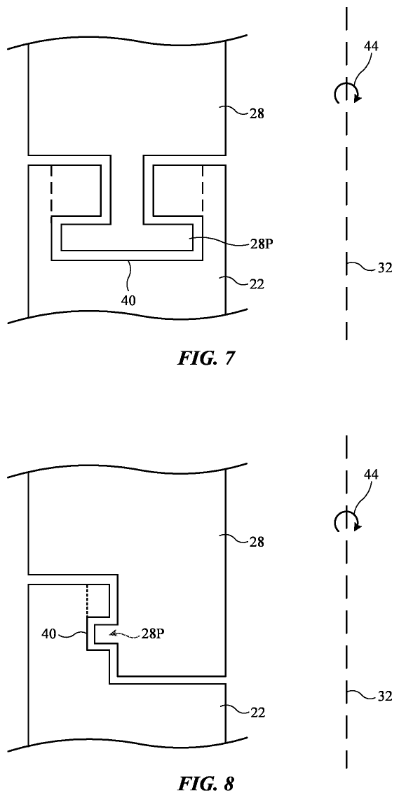

If desired, pin 28P may have portions that extend both radially outward and inward, as shown in FIG. 7. In this type of arrangement, slot 40 may be configured to form a corresponding T-shaped groove in support 22 and may have slot portions (slots) that face both inwardly and outwardly.

As shown in the arrangement of FIG. 8, pin 28P may be configured to protrude radially outward (away from axis 32) and slot 40 may face radially inward towards axis 32.

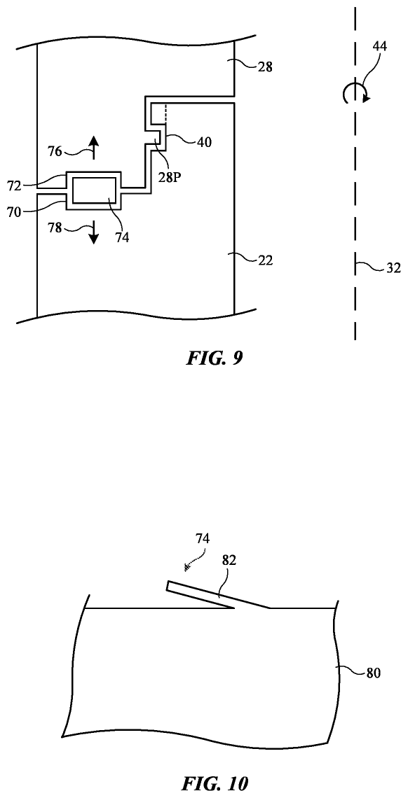

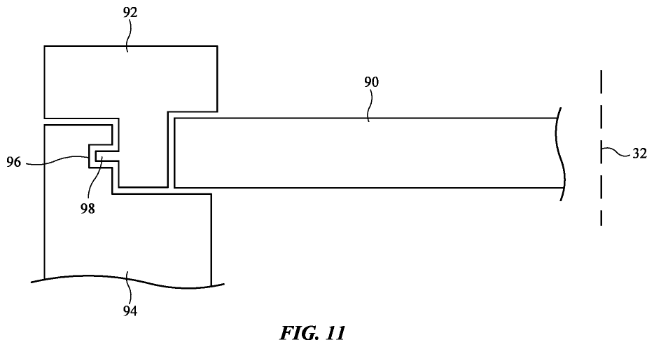

FIG. 9 shows how axial loading may be provided using a spring such as spring 74. Spring 74 may be formed from a wave spring, one or more coil springs, a foam ring, one or more bent flexible arms, and/or other structures configured to provide axial biasing. In the example of FIG. 9, support 28 has a ring-shaped groove such as groove 72 and support 22 has a ring-shaped groove such as groove 70. These grooves may run around the corresponding peripheral edges of supports 20 and 22 as shown in FIG. 9 and may be configured to receive spring 74. When support 28 is attached to support 22 using the bayonet mount formed using pins 28P and slots 40, spring 74 is compressed between structures 20 and 22. Spring 74 thereafter provides a restoring force that pushes support 28 in direction 76 and pushes support 22 in opposing direction 78. By pushing supports 28 and 22 away from each other in this way, spring 74 provides lens 30 with a desired axial loading that helps maintain lens 30 at a known axial location with respect to lens 18 of assembly 24 and therefore helps ensure satisfactory optical performance for lens 30 and assembly 24 (e.g., by ensuring that lens 30 is aligned with lens 18).

FIG. 10 shows how spring 74 may be formed by integral flexible arms such as arm 82 on structure 80 (which may be, for example, a portion of support 28 and/or a portion of support 22). Other spring configurations may be used, if desired.

In the examples of FIGS. 6, 7, 8, and 9, pins 28P are formed from protrusions in support 28 of lens 30 and slots 40 are formed from recesses in support 22 of assembly 24. If desired, pins 28P may be formed from protrusions in support 22 and slots 40 may be formed from recesses in support 28. The examples of FIGS. 6, 7, 8, and 9 are illustrative.

FIG. 10 shows how other structures in device 10 such as lens retaining rings may be provided with bayonet mounts. In the example of FIG. 10, lens 90 of assembly 24 or of lens 30 may be held in place on support 94 using retaining ring support 92. Support 92 and/or support 94 may be provided with mating protrusions and grooves such as illustrative pin 98 and slot 96 to form a push-and-twist mount (e.g., a bayonet mount). This allows support 92 to be attached to support 94 to capture lens 90 along its peripheral edge and thereby mount lens 90 to support 94. In general, structures in assemblies 24 such as lenses, lens barrels, retaining rings (trim rings) and/or other structures may be provided with bayonet mounts. The use of bayonet mounts for retaining rings and removable prescription lenses is illustrative.

To help protect the privacy of users, any personal user information that is gathered by sensors may be handled using best practices. These best practices including meeting or exceeding any privacy regulations that are applicable. Opt-in and opt-out options and/or other options may be provided that allow users to control usage of their personal data.

The foregoing is merely illustrative and various modifications can be made to the described embodiments. The foregoing embodiments may be implemented individually or in any combination.

What is claimed is:

1. A head-mounted device operable with a removable vision correction lens, comprising:
a head-mounted housing;
a lens support coupled to the head-mounted housing;
a non-removable lens supported by the lens support, wherein the lens support has a push-and-twist mount configured to receive the removable vision correction lens and wherein the push-and-twist mount is configured to maintain the removable vision correction lens in alignment with the non-removable lens when the removable vision correction lens is attached to the lens support with the push-and-twist mount; and
a display configured to provide an image to an eye box through the non-removable lens and the removable vision correction lens when the removable vision correction lens is attached to the lens support.

2. The head-mounted device defined in claim 1 wherein the push-and-twist mount comprises a slot on the lens support that is configured to receive a protrusion on the removable vision correction lens.

3. The head-mounted device defined in claim 1 wherein the lens support comprises first and second slots on opposing sides of the lens support that are configured to receive respective first and second protrusions on the removable vision correction lens.

4. The head-mounted device defined in claim 1 wherein the push-and-twist mount comprises a pin on the lens support that is configured to be received by a slot on the removable vision correction lens.

5. The head-mounted device defined in claim 1 wherein the push-and-twist mount comprises first and second pins on opposing sides of the lens support that are configured to be received by respective first and second slots on the removable vision correction lens.

6. The head-mounted device defined in claim 1 further comprising a spring adjacent to the lens support that is configured to push the removable vision correction lens away from the lens support.

7. A head-mounted device operable with a removable vision correction lens, the head-mounted device comprising:
a head-mounted housing;
a fixed lens in the head-mounted housing; and
a lens support that supports the fixed lens and that has a bayonet mount that maintains the removable vision correction lens in alignment with the fixed lens.

8. The head-mounted device defined in claim 7 wherein the bayonet mount comprises a protrusion on the lens support that is configured to be received within a recess in the removable vision correction lens.

9. The head-mounted device defined in claim 8 wherein the protrusion on the lens support comprises a pin and wherein the recess in the removable vision correction lens comprises a slot configured to receive the pin.

10. The head-mounted device defined in claim 7 wherein the bayonet mount comprises a recess in the lens support that is configured to receive a protrusion on the removable vision correction lens.

11. The head-mounted device defined in claim 10 wherein the protrusion on the removable vision correction lens comprises a pin and wherein the recess in the lens support comprises a slot configured to receive the pin.

12. A head-mounted device operable with first and second removable vision correction lenses, comprising:
a head-mounted housing;
first and second lens supports coupled to the head-mounted housing; and
first and second lenses mounted respectively to the first and second lens supports, wherein the first and second lens supports are configured to form first and second bayonet mounts with which the first and second removable vision correction lenses are removably attached to the first and second lens supports, respectively.

13. The head-mounted device defined in claim 12 further comprising first and second displays configured to provide respective first and second images to first and second eye boxes through the first and second lenses and the first and second removable vision correction lenses when the first removable vision correction lens is attached to the first lens support and the second removable vision correction lens is attached to the second lens support.

14. The head-mounted device defined in claim 13 wherein the first bayonet mount comprises a first pin on the first lens support and wherein the second bayonet mount comprises a second pin on the second lens support.

15. The head-mounted device defined in claim 13 wherein the first bayonet mount comprises first and second pins on opposing sides of the first lens support that are configured to be received by respective first and second slots in the first removable vision correction lens and wherein the second bayonet mount comprises third and fourth pins on opposing sides of the second lens support that are configured to be received by respective third and fourth slots in the second removable vision correction lens.

16. The head-mounted device defined in claim 15 wherein the first and second pins protrude radially outward from a first rotation axis about which the first removable vision correction lens rotates when attaching to the first lens support and wherein the third and fourth pins protrude radially outward from a second rotation axis about which the second removable vision correction lens rotates when attaching to the second lens support.

17. The head-mounted device defined in claim 15 wherein the first and second pins protrude radially inward towards a first rotation axis about which the first removable vision correction lens rotates when attaching to the first lens support and wherein the third and fourth pins protrude radially inward toward a second rotation axis about which the second removable vision correction lens rotates when attaching to the second lens support.

18. The head-mounted device defined in claim 13 wherein the first bayonet mount comprises first and second slots on opposing sides of the first lens support that are configured to receive respective first and second pins on the first removable vision correction lens and wherein the second bayonet mount comprises third and fourth slots on opposing sides of the second lens support that are configured to receive respective third and fourth pins on the second removable vision correction lens.

19. The head-mounted device defined in claim 18 wherein the first and second slots face radially outward from a first rotation axis about which the first removable vision correction lens rotates when attaching to the first lens support and wherein the third and fourth slots face radially outward from a second rotation axis about which the second removable vision correction lens rotates when attaching to the second lens support.

20. The head-mounted device defined in claim 18 wherein the first and second slots face radially inward towards a first rotation axis about which the first removable vision correction lens rotates when attaching to the first lens support and wherein the third and fourth slots face radially inward toward a second rotation axis about which the second removable vision correction lens rotates when attaching to the second lens support.
